(19) United States
(12) Patent Application Publication
(10) Pub. No.: US 2014/0207463 A1
(43) Pub. Date: Jul. 24, 2014

(54) GENERATION METHOD OF AUDIO SIGNAL, AUDIO SYNTHESIZING DEVICE

(71) Applicant: Panasonic Corporation, Osaka (JP)

(72) Inventor: Masahiro NAKANISHI, Kyoto (JP)

(73) Assignee: PANASONIC CORPORATION, Osaka (JP)

(21) Appl. No.: 14/158,597

(22) Filed: Jan. 17, 2014

(30) Foreign Application Priority Data
Jan. 23, 2013 (JP) 2013-009715
Dec. 18, 2013 (JP) 2013-260918

(51) Int. Cl. G10L 13/02

(52) U.S. Cl. CPC G10L 13/02
USPC 704/261

(57) ABSTRACT

An audio signal method of the present disclosure includes: inputting a plurality of variables including at least a first variable indicating an opening degree of a throat, which interiorly includes a vocal cord, with respect to a vocal cord model configured to output a second variable indicating an opening degree of the vocal cord according to reception of input of the plurality of variables, the first variable being greater than the second variable; and generating an audio signal in which a level of a non-integer harmonic sound is changed, by controlling the second variable.

### BACKGROUND OF THE INVENTION

1. Field of the Invention

The present disclosure relates to a generation method of an audio signal, and an audio synthesizing device.

2. Description of the Related Art

“Chaotic and Fractal properties in vocal Sound and its Synthesis model” described on pp. 39 to 47 of Nagaoka University of Technology Research report Vol. 21 by Hiroyuki Koga and Masahiro Nakagawa discloses a vocal cord vibration model. The vocal cord vibration model is a two mass model. That is, the vocal cord vibration model uses objects having two different masses to imitate the shape and motion of the vocal cord.

### SUMMARY OF THE INVENTION

The present disclosure provides a synthesizing method of an audio signal that can express strength and weakness of a note such as weak voice, yelling voice, and the like.

To achieve the above object, an audio signal method of the present disclosure includes: inputting a plurality of variables including at least a first variable indicating an opening degree of a throat, which interiorly includes a vocal cord, with respect to a vocal cord model configured to output a second variable indicating an opening degree of the vocal cord according to reception of input of the plurality of variables, the first variable being greater than the second variable; and generating an audio signal in which a level of a non-integer order harmonic sound is changed, by controlling the second variable.

The synthesizing method of the audio signal of the present disclosure thus can express strength and weakness of the note such as weak voice, yelling voice, and the like.

### BRIEF DESCRIPTION OF DRAWINGS

FIG. 1 is a schematic view describing an outline of audio synthesizing device 500;

FIG. 2 is a schematic view showing a configuration of vocal cord model 110 simulated by audio synthesizing device 500;

FIG. 3 is a schematic view describing a plurality of states of vocal cord model 110;

FIG. 4 is a schematic view showing a configuration of vocal tract acoustic model 150 simulated by audio synthesizing device 500;

FIG. 5 is a schematic view showing a configuration of control unit 100;

FIG. 6 is a schematic view showing a specific example of message file 102;

FIG. 7 is a view showing temporal change of Φ, which is an opening degree of the throat;

FIG. 8 is a view showing a time waveform of x2, which is a displacement of mass point 114;

FIG. 9 is a view showing an amplitude frequency spectrum of the generated audio signal;

FIG. 10 is a view describing a timing of vocalization for each phoneme;

FIG. 11 is a schematic view describing a plurality of states of vocal cord model 110;

FIG. 12 is a schematic view showing a configuration of control unit 700;

FIG. 13 is a schematic view showing a specific example of message file 702;

FIG. 14 is a schematic view showing a specific example of information stored by table 705;

FIG. 15 is a schematic view showing a time waveform of x2 indicating a displacement of mass point 114;

FIG. 16 is a schematic view showing an amplitude frequency spectrum of audio signal Pv; and

FIG. 17 is a schematic view showing a changing example of various types of parameters when transitioning from a coupled vibration mode to a simple vibration mode.

### DETAILED DESCRIPTION OF THE INVENTION

Exemplary embodiments will be hereinafter described in detail while appropriately referencing the drawings. However, the description that may be in detail more than necessary may be omitted. For example, the detailed description on matters well known and the redundant description on substantially the same configuration may be omitted. This is to avoid the following description from becoming unnecessarily redundant and to facilitate the understanding of those skilled in the art.

The inventor(s) provide the accompanying drawings and the following descriptions to enable those skilled in the art to sufficiently understand the present disclosure, and do not intend to limit the main subject described in the Claims with the drawings and the following description.

### First Exemplary Embodiment

A first exemplary embodiment will be described with reference to the drawings.

[1-1. Outline]

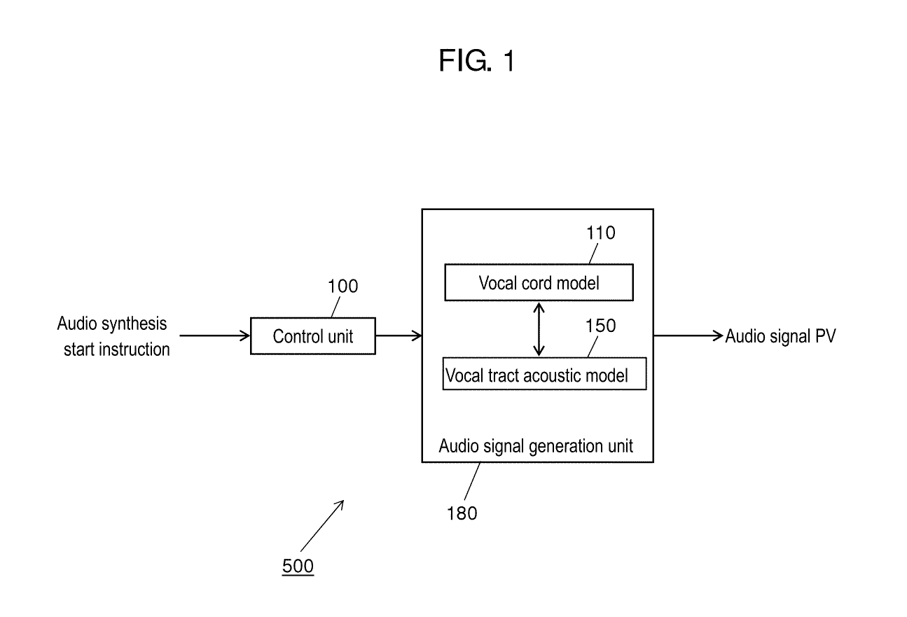

An outline of audio synthesizing device 500 will be described with reference to FIG. 1. FIG. 1 is a schematic view describing an outline of audio synthesizing device 500. Audio synthesizing device 500 imitates a vocalization mechanism of a human based on a start instruction of audio synthesis to generate an audio signal.

Audio synthesizing device 500 includes control unit 100 and audio signal generation unit 180. Control unit 100 controls audio signal generation unit 180. Audio signal generation unit 180 generates the audio signal based on an input from control unit 100. Audio signal generation unit 180 includes vocal cord model 110 and vocal tract acoustic model 150. Vocal cord model 110 is a model that imitates the vocal cord in a throat of a human. Vocal tract acoustic model 150 is a model that imitates the vocal tract in the throat of the human. Control unit 100 outputs a plurality of variables including at least a variable indicating an opening degree of the throat of the human to audio signal generation unit 180 when receiving a start instruction of audio synthesis. Audio signal generation unit 180 inputs the variable indicating the opening degree of the throat of the human, which input is received from control unit 100, to vocal cord model 110. Vocal cord model 110 outputs a variable indicating an opening degree of the vocal cord of the human to vocal tract acoustic model 150 based on the variable indicating the opening degree of the throat of the human. Vocal tract acoustic model 150 generates the audio signal based on the variable indicating the opening degree of the vocal cord of the human, which input is received.

That is, the synthesizing method of the audio signal used by audio synthesizing device 500 includes inputting a plurality of variables including at least a first variable indicating an opening degree of a throat, which interiorly includes a vocal cord, with respect to a vocal cord model that outputs a second variable indicating an opening degree of the vocal cord according to the reception of inputs of the plurality of variables, the first variable being greater than the second variable. The synthesizing method of the audio signal used by audio synthesizing device 500 also includes controlling the second variable to generate the audio signal in which the level of non-integer harmonic sound is changed.

Thus, the synthesizing method of the audio signal used by audio synthesizing device 500 can express strength and weakness of the note such as weak voice, yelling voice, and the like.

[1-2. Configuration]

[1-2-1. Vocal Cord Model]

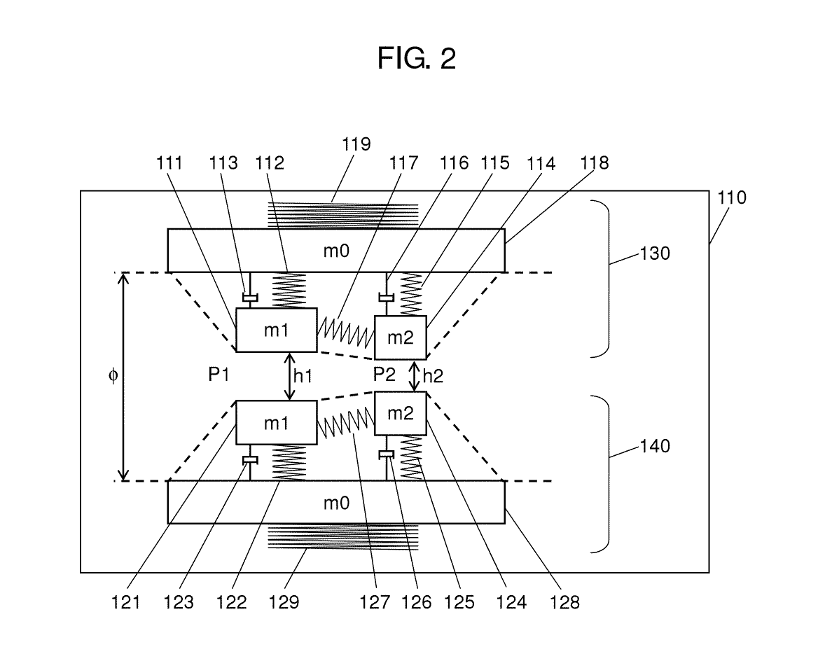

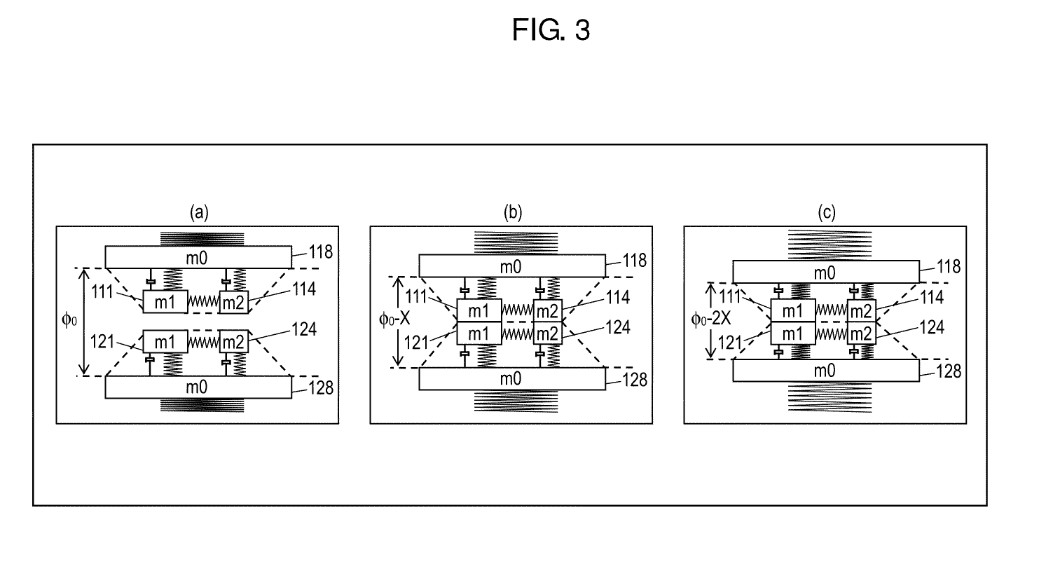

Vocal cord model 110 simulated by audio synthesizing device 500 will be described with reference to FIG. 2 and FIG. 3. FIG. 2 is a schematic view showing a configuration of vocal cord model 110 simulated by audio synthesizing device 500. FIG. 3 is a schematic view describing a plurality of states of vocal cord model 110. Vocal cord model 110 is a block that imitates the up and down movement of the vocal cord. Vocal cord model 110 is incorporated in a program imitating the movement of a physical configuration as shown in FIG. 2.

Vocal cord model 110 simulated by audio synthesizing device 500 is a so-called two-mass model. That is, vocal cord model 110 uses objects having two different masses, namely, m1 and m2, to imitate the shape of the vocal cord. Vocal cord model 110 has a vertically symmetric configuration. An upper part of vocal cord model 110 includes mass point 118, spring 119, spring 112, dashpot 113, mass point 111, spring 115, dashpot 116, mass point 114, and spring 117. A lower part of vocal cord model 110 includes mass point 128, spring 129, spring 122, dashpot 123, mass point 121, spring 125, dashpot 126, mass point 124, and spring 127.

Mass point 111, mass point 114, mass point 121, and mass point 124 are objects imitating the shape of the inner periphery of the vocal cord. The mass of mass point 111 and the mass of mass point 121 are m1 and are the same. The mass of mass point 114 and the mass of mass point 124 are m2 and are the same. Here, m1 is a value greater than m2. The extent of movement of the inner periphery of the vocal cord can be defined by to what magnitude to determine m1 and m2.

Spring 112, spring 115, spring 122, and spring 125 are springs imitating expansion and contraction of the vocal cord. Spring 112, spring 115, spring 122, and spring 125 imitate the state in which the vocal cord is contracted by elongating. Spring 112, spring 115, spring 122, and spring 125 imitate the state in which the vocal cord is expanded by contracting. The easiness to elongate and the easiness to contract of the spring can be defined by determining a spring constant of such springs.

Dashpot 113, dashpot 116, dashpot 123, and dashpot 126 imitate the viscosity of the vocal cord. Dashpot 113, dashpot 116, dashpot 123, and the dashpot 126 imitate the vocal cord of high stickiness by defining high viscosity coefficient. Dashpot 113, dashpot 116, dashpot 123, and dashpot 126 imitate the vocal cord of low stickiness by defining low viscosity coefficient. The easiness to elongate and the easiness to contract of the spring can be defined by determining the viscosity coefficient of the dashpots.

Spring 117 and spring 127 imitate a coupled vibration by the vocal cord, which includes mass point 111 and mass point 121, and the vocal cord, which includes mass point 114 and mass point 124. The extent at which the coupled vibration occurs can be defined by determining the spring constants of such springs.

Mass point 118 and mass point 128 are objects imitating the shape of the inner periphery of the throat interiorly including the vocal cord. The masses of mass point 118 and mass point 128 are m0, and are the same. Here, m0 is a value greater than m1. The extent of movement of the inner periphery of the throat can be defined by determining to what magnitude to set m0.

Spring 119 and spring 129 are springs for imitating expansion and contraction of the throat. Spring 119 and spring 129 imitate the state in which the throat is contracted by elongating. Spring 119 and spring 129 imitate the state in which the throat is expanded by contracting. The easiness to open and the difficulty to open of the throat can be defined by determining the spring constant of such springs. For example, the opening degree of the throat may be as shown in FIGS. 3(a), 3(b), and 3(c). FIG. 3(a) shows a case in which the opening degree of the throat is Φ₀. FIG. 3(b) shows a case in which the opening degree of the throat is Φ₀−X. FIG. 3(c) shows a case in which the opening degree of the throat is Φ₀−2X. The close attachment degree of mass point 111 and mass point 121, as well as the close attachment degree of mass point 114 and mass point 124 differ depending on the value taken by Φ₀, which is the opening degree of the throat. As a result, the vibration mode of each vocal cord differs.

Audio synthesizing device 500 according to the present exemplary embodiment prepares vocal cord model 110 as a program simulating the movement of the physical configuration described above. Sound pressure P1 and sound pressure P2, which are generated in a gap of the vocal cord, generated by Ps imitating the pressure of the lung are input as external forces from vocal tract acoustic model 150 (to be described later) to vocal cord model 110. Vocal cord model 110 outputs h1 and h2, which imitate the intervals of the vocal cord, to vocal tract acoustic model 150 with such external forces applied. Vocal tract acoustic model 150 receives h1 and h2 as inputs and generates the audio signal.

[1-2-2. Vocal Tract Model]

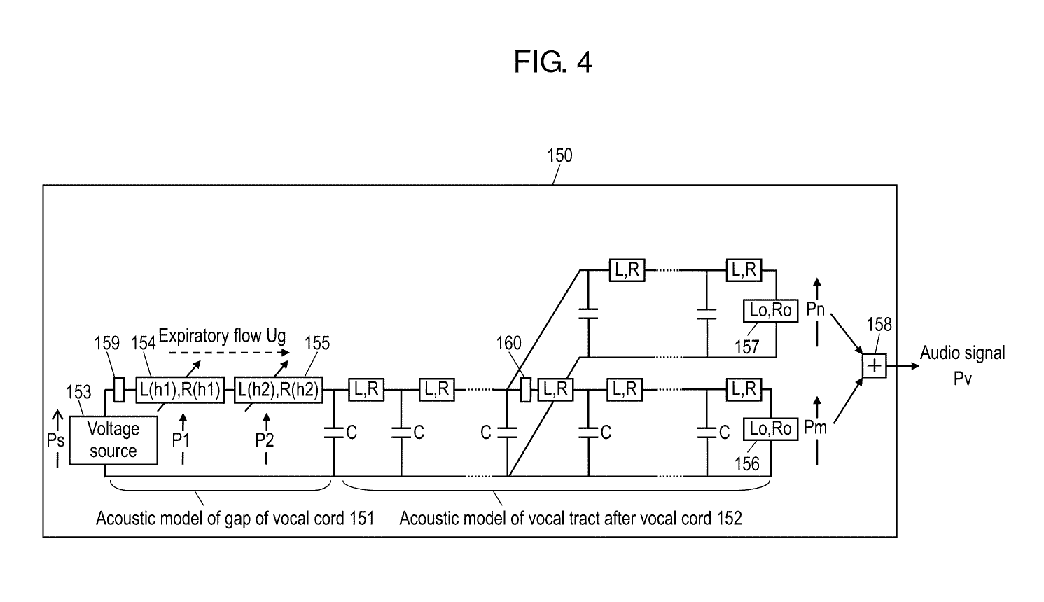

Vocal tract acoustic model 150 simulated by audio synthesizing device 500 will be described with reference to FIG. 4. FIG. 4 is a schematic view showing a configuration of vocal tract acoustic model 150 simulated by audio synthesizing device 500. Vocal tract acoustic model 150 is a block that imitates a resonance to an opening from lung to mouth and an opening from lung to nose. Vocal tract acoustic model 150 is incorporated in a program imitating the movement of the physical configuration as shown in FIG. 4.

Vocal tract acoustic model 150 imitates the vocal tract by simulating acoustic model 151 of a gap of the vocal cord and acoustic model 152 of the vocal tract after the vocal cord. Acoustic model 151 of the gap of the vocal cord is a block that imitates the movement of the gap of the vocal cord. Acoustic model 152 of the vocal tract after the vocal cord is a block that imitates the movement of the vocal tract after the vocal cord.

Acoustic model 151 of the gap of the vocal cord includes voltage source 153, acoustic impedance 154 of the gap of the vocal cord, acoustic impedance 155 of the gap of the vocal cord, and turbulent noise source 159. Voltage source 153 is voltage source for imitating pressure Ps of the lung. The strength of the sound pressure, which is the external force applied to the gap of the vocal cord, can be adjusted by determining the voltage value of voltage source 153. Acoustic impedance 154 of the gap of the vocal cord and acoustic impedance 155 of the gap of the vocal cord are blocks that imitate the movement of the vocal tract. Specifically, acoustic impedance 154 of the gap of the vocal cord and acoustic impedance 155 of the gap of the vocal cord are blocks simulating a circuit in which acoustic inertance L and acoustic resistance R are connected in series.

Acoustic model 152 of the vocal tract after the vocal cord simulates a circuit in which a plurality of closed loop circuits, each including acoustic inertance L, acoustic resistance R, and acoustic compliance C, is cascade connected. Acoustic model 152 of the vocal tract after the vocal cord also simulates a circuit branched from the middle to a circuit imitating an acoustic tube of the mouth and a circuit imitating an acoustic tube of the nose. In the vocal tract of a human, the portion corresponding to such branching point is called a palatine sail. The palatine sail controls the air flow flowing into the acoustic tube of the mouth. In the present exemplary embodiment, the control is carried out in switch 160.

The values of acoustic inertance L, acoustic resistance R, and acoustic compliance C in acoustic model 151 of the gap of the vocal cord and acoustic model 152 of the vocal tract after the vocal cord are values uniquely determined by the cross-sectional area (hereinafter referred to as a vocal tract cross-sectional area) obtained when the vocal tract to imitate is sliced to a plurality of stages at equal interval, and a constant of an air density, and the like in the vocal tract to imitate. Generally, if a phoneme form to vocalize and h1 and h2, which are intervals of the vocal cord, are determined, the typical vocal tract cross-sectional area, acoustic impedance 154 of the gap of the vocal cord, and acoustic impedance 155 of the gap of the vocal cord are uniquely determined.

Acoustic model 152 of the vocal tract after the vocal cord includes radiation impedance 156 of the opening of the mouth and radiation impedance 157 of the opening of the nose. The voltage generated by radiation impedance 156 of the opening of the mouth becomes sound pressure Pm radiated from the mouth. The voltage generated by radiation impedance 157 of the opening of the nose becomes sound pressure Pn radiated from the nose. Pm and Pn are added by adder 158 to generate desired audio signal Pv.

[1-2-3. Configuration of Control Unit]

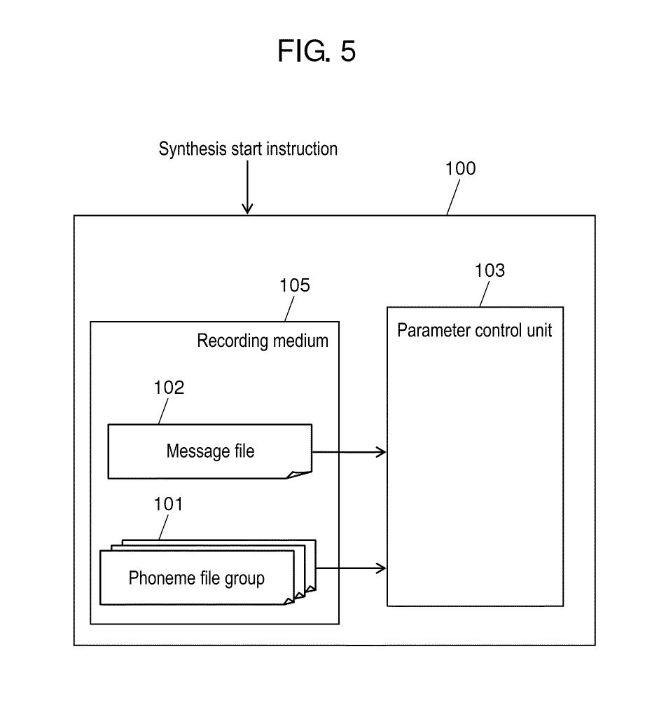

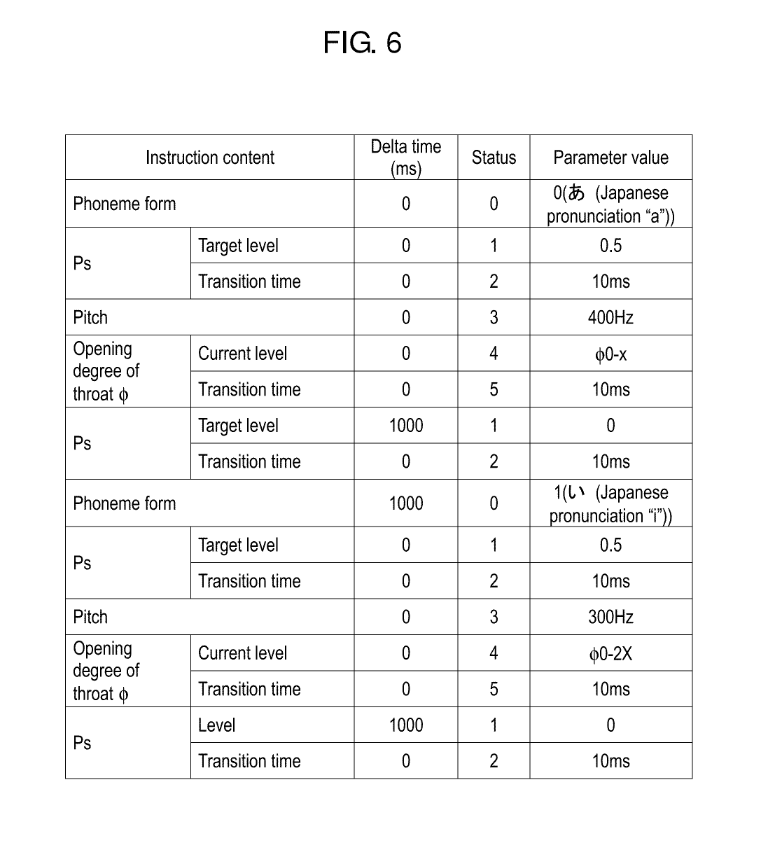

A configuration of control unit 100 will be described with reference to FIGS. 5 and 6. FIG. 5 is a schematic view showing a configuration of control unit 100. FIG. 6 is a schematic view showing a specific example of message file 102. Control unit 100 includes parameter control unit 103 and recording medium 105. Parameter control unit 103 is a controller for controlling entire audio synthesizing device 500. For example, parameter control unit 103 is configured by a CPU (Central Processing Unit). Recording medium 105 is a memory for storing data. For example, recording medium 105 is configured by a non-volatile storage medium such as a flash memory, and the like.

Recording medium 105 stores in advance phoneme file group 101. Recording medium 105 also stores message file 102 externally received with a synthesis start instruction.

Phoneme file group 101 is a collection of files storing parameter values necessary for standard vocalization of each phoneme such as “ [symbol] (Japanese pronunciation “a”)”, “ [symbol] (Japanese pronunciation “i”)”, and the like. For example, phoneme file group 101 stores the parameter value specifying the shape of the vocal tract. The parameter value specifying the shape of the vocal tract includes, for example, values of acoustic inertance L, acoustic resistance R, and acoustic compliance C included in acoustic model 152 of the vocal tract after the vocal cord of the vocal tract. Phoneme file group 101 also includes the mass of each mass point, the spring constant of each spring, and the standard value of the viscosity coefficient of each dashpot, which are the parameter values specifying the shape and property of the vocal cord.

Message file 102 is a file created by a user. Message file 102 indicates what kind of audio to generate at what timing. That is, message file 102 is a file described with a dynamically changing parameter value such as the pitch and strength of what extent to emit what phoneme and at what time. For example, message file 102 is a file described with information shown in FIG. 6. For example, message file 102 shown in FIG. 6 is a file for generating in order “ [symbol] (Japanese pronunciation “a”)”, “ [symbol] (Japanese pronunciation “i”)”. Message file 102 has the corresponding delta time, status, and parameter value with respect to the phoneme form to generate, Ps, which is the pressure of the lung, the pitch indicating the pitch of the voice, and Φ indicating the opening degree of the throat.

[1-3. Operation]

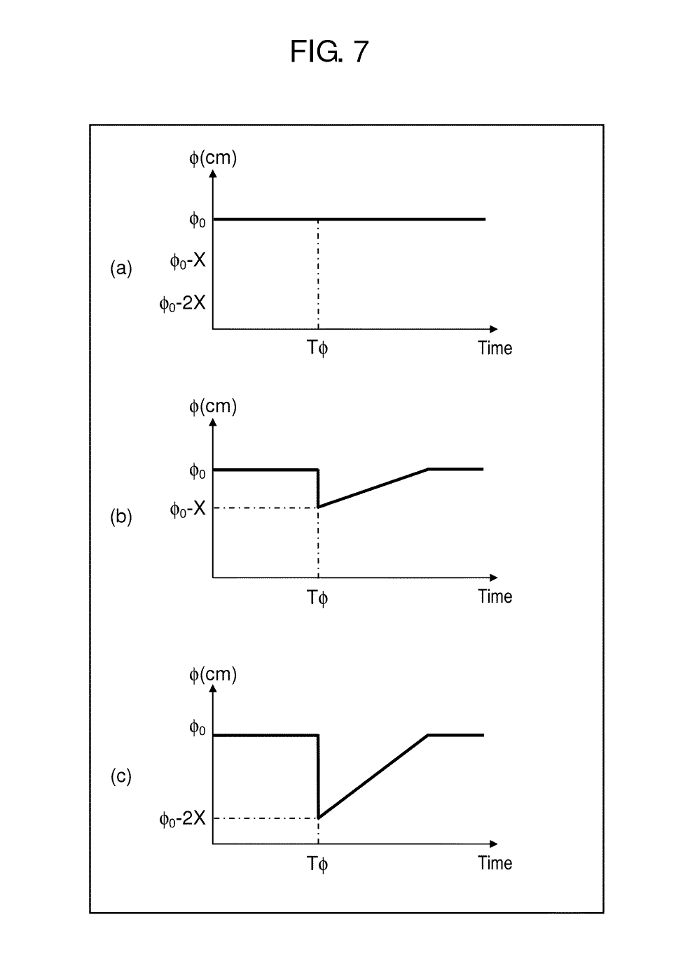

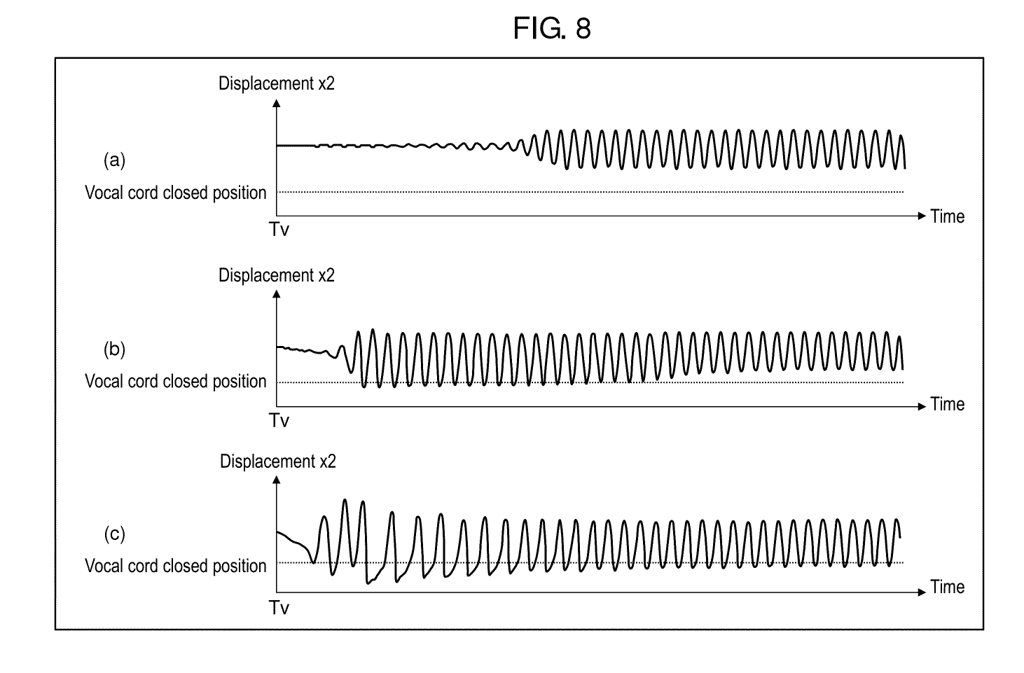

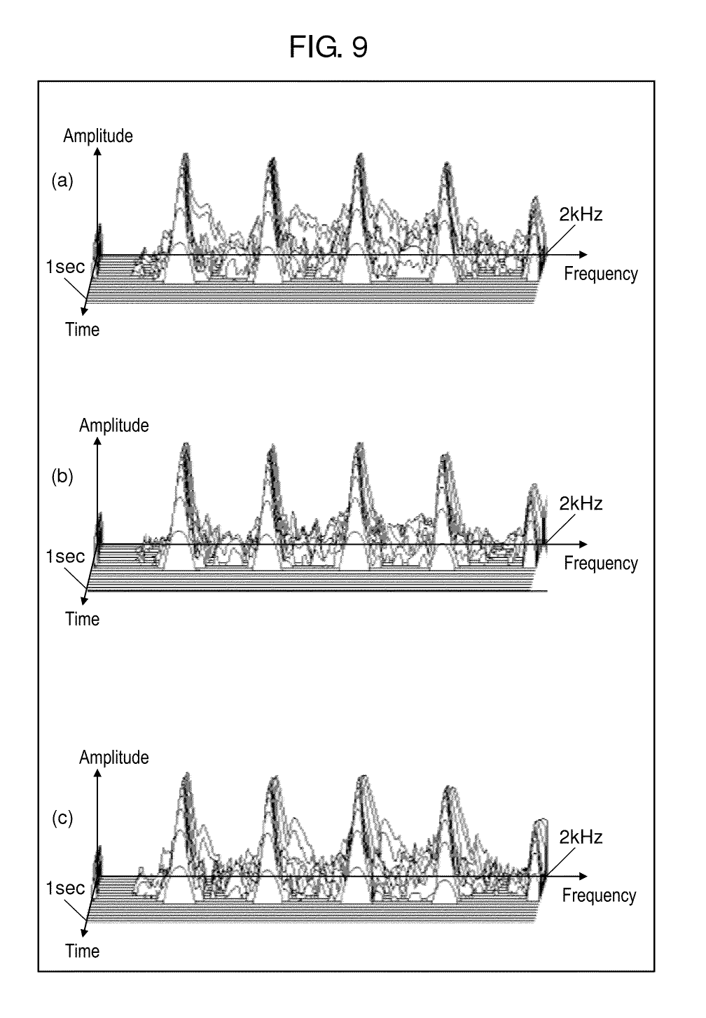

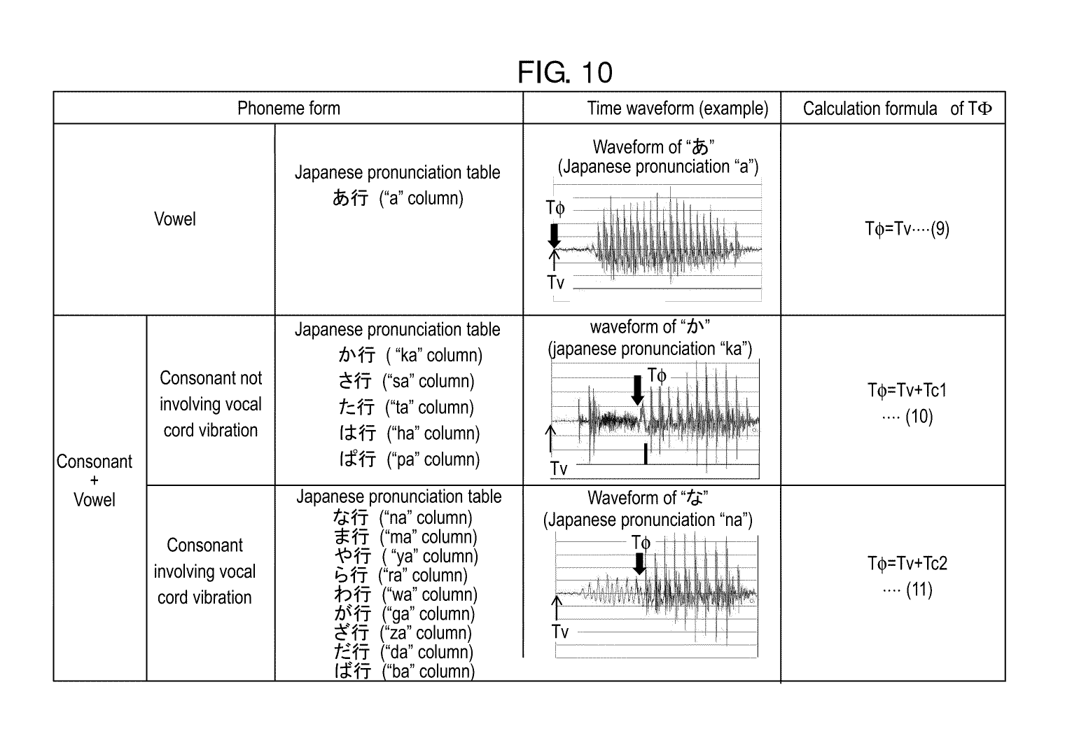

The operation of audio synthesizing device 500 will be described with reference to FIGS. 7 to 10. FIG. 7 is a view showing a temporal change of Φ, which is the opening degree of the throat. FIG. 8 is a view showing a time waveform of x2, which is the displacement of mass point 114. FIG. 9 is a view showing an amplitude frequency spectrum of the generated audio signal. FIG. 10 is a view describing the timing of vocalization for each phoneme.

When externally receiving the synthesis start instruction, parameter control unit 103 sequentially reads out the parameter values described in message file 102. Parameter control unit 103 provides the readout parameter values themselves, or the parameter values generated based on the readout parameter values to vocal cord model 110 and vocal tract acoustic model 150. Vocal cord model 110 and vocal tract acoustic model 150 generate audio signal Pv based on the provided parameter values.

Parameter control unit 103 references message file 102 shown in FIG. 6, and sequentially reads out parameter values according to the delta time. Assuming the time at which the synthesis start instruction is received is reference time T₀, at a time the delta time is added to T₀, parameter control unit 103 executes the process based on the corresponding instruction content and the corresponding parameter value described in message file 102.

Parameter control unit 103 first reads out the parameter values for six rows from the first row of FIG. 6 at the timing of reference time T₀. Status 0 specifies that the corresponding parameter value in message file 102 is the phoneme form. In the case in which the parameter value is zero, parameter control unit 103 reads out a phoneme file corresponding to “ [symbol] (Japanese pronunciation “a”)” from phoneme file group 101. Parameter control unit 103 then reads out various types of parameter values described in the phoneme file. Parameter control unit 103 then transfers the read parameter values to vocal cord model 110 and vocal tract acoustic model 150. Assuming the time at which the phoneme form is specified is vocalization start time Tv, Tv=T0 in the present example.

Status 1 specifies that the corresponding parameter value is a target level of pressure Ps of the lung. Status 2 specifies that the corresponding parameter value is a transition time of pressure Ps of the lung. The transition time is the time for Ps to transition from the current level to the target level. Parameter control unit 103 executes an initialization process at the timing of reference time T0. Specifically, parameter control unit 103 resets the current value of Ps to zero. Parameter control unit 103 transitions the value of Ps toward 0.5, which is the target level, in a time of 10 ms, in parallel with the initialization process. The parameter value during the transition is transferred to voltage source 153 in vocal tract acoustic model 150 by parameter control unit 103 for each sampling time interval.

Status 3 specifies that the corresponding parameter value is a pitch (pitch). Parameter control unit 103 determines the parameter value such as spring constant of each mass point such that natural frequencies of mass point 114 and mass point 124 of vocal cord model 110 become 400 Hz based on the pitch. The method for determining the natural frequency may be any method in the conventional art.

Status 4 specifies that the corresponding parameter value is the current level of variable Φ specifying the opening degree of the throat.

Status 5 specifies that the corresponding parameter value is the transition time of (D. The transition time is the time for the value of Φ to transition from the current level to the target level. The target level of Φ is assumed to be fixed at Φ₀ herein. Parameter control unit 103 instantly sets the current value of Φ to Φ₀−X, and transitions the value toward Φ₀, which is the target level, in a time of 10 ms at the timing of reference time T0. The parameter value during the transition is transferred to vocal tract acoustic model 150 for each sampling time interval.

In the example of message file 102 shown in FIG. 6, Φ changes in a manner shown in FIG. 7(b). Vocal cord model 110 starts vocalization in the state of FIG. 3(b). The current level of Φ of the fifth row in message file 102 is set to Φ₀ when starting the vocalization in the state of FIG. 3(a), and the current level of Φ of the fifth row in message file 102 is set to Φ₀−2X when starting the vocalization in the state of FIG. 2(c).

Similarly hereinafter, readout is carried out up to the last row of message file 102 to generate audio signal Pv that vocalizes “ [symbol] (Japanese pronunciation “a”)” and “ [symbol] (Japanese pronunciation “i”)” at an interval of 2000 ms.

The difference in the properties of audio signal Pv generated in the respective states of FIG. 3(a), FIG. 3(b), and FIG. 3(c) will now be described. Vocal cord model 110 includes upper vocal cord model 130 at the upper part and lower vocal cord model 140 at the lower part, as described above. The respective vocal cord models symmetrically vibrate. In the present disclosure, only the behavior of upper vocal cord model 130 of the upper part will be considered. Mass point 118 has sufficiently large impedance compared to mass point 111 and mass point 114. In other words, mass point 118 is assumed to remain stationary without being influenced by the vibration of mass point 111 and mass point 114. Therefore, the displacement of mass point 118 changes only to change opening degree Φ of the throat. With regards to the vibration of the vocal cord, only the vibration of mass point 111 and mass point 114 will be considered. First, a motion equation of mass point 111 and mass point 114, which vocal cord model 110 imitates as a program, will be described. Subsequently, the difference in the properties of audio signal Pv generated in the respective states of FIG. 3(a), FIG. 3(b), and FIG. 3(c) will be described.

The motion equation of mass point 111 is expressed with the following Equation (1). The motion equation of mass point 114 is expressed with the following Equation (2).

$$\begin{matrix} [ Equation 1 ] & \\ {m}_{1} \frac{{d}^{2} {x}_{1}}{d {t}^{2}} = F + {G}_{1} ( o , {x}_{1} ) + ( {k}_{1} {f}_{k} ( {x}_{1} ) ) - ( {k}_{c} {f}_{c} ( {x}_{1} - {x}_{2} ) ) - ( {μ}_{1} {f}_{μ} ( {x}_{1} ) \frac{d {x}_{1}}{d t} ) & ( 1 ) \\ [ Equation 2 ] & \\ {m}_{2} \frac{{d}^{2} {x}_{2}}{d {t}^{2}} = {F}_{2} + {G}_{2} ( o , {x}_{2} ) + ( {k}_{2} {f}_{k} ( {x}_{2} ) ) - ( {k}_{c} {f}_{c} ( {x}_{2} - {x}_{1} ) ) - ( {μ}_{2} {f}_{μ} ( {x}_{2} ) \frac{d {x}_{2}}{d t} ) & ( 2 )\end{matrix}$$

In Equation (1), the left side indicates the inertia force of mass point 111. In Equation (2), the left side indicates the inertia force of mass point 114. In Equation (1), a first term of the right side indicates the external force generated by sound pressure P1 acting on mass point 111. In Equation (2), a first term of the right side indicates the external force generated by sound pressure P2 acting on mass point 114. The external force acting on mass point 111 is expressed with the following Equation (3). The external force acting on mass point 114 is expressed with the following Equation (4).

[Equation 3]

F₁=P₁A₁ (3)

[Equation 4]

F₂=P₂A₂ (4)

A1 in Equation (3) indicates the surface area of the bottom surface of mass point 111. A2 in Equation (4) indicates the surface area of the bottom surface of mass point 114. P1 and P2 indicate variables generated in acoustic impedance 154 of the gap of the vocal cord and acoustic impedance 155 of the gap of the vocal cord in vocal tract acoustic model 150. P1 and P2 are referenced by vocal cord model 110 each time P1 and P2 are calculated in vocal tract acoustic model 150. A circuit equation of vocal tract acoustic model 150 follows Non-Patent Document 1 described above.

A second term of the right side in Equation (1) indicates a drag acting on mass point 111. A second term of the right side in Equation (2) indicates a drag acting on mass point 114. The drag acting on mass point 111 is generated when colliding with opposing mass point 121. The drag acting on mass point 111 is expressed as a function of Φ and x1. Here, x1 is a displacement of mass point 111. The drag acting on mass point 114 is generated when colliding with opposing mass point 124. The drag acting on mass point 114 is expressed as a function of Φ and x2. Here, x2 is a displacement of mass point 114.

A third term of the right side in Equation (1) indicates a restoring force of spring 112. A third term of the right side in Equation (2) indicates a restoring force of spring 115. Here, k1 and k2 indicate spring constants. Here, fk is a function representing non-linearity of the spring constant. A fourth term of the right side in Equations (1) and (2) indicates a restoring force of spring 117. Here, kc indicates a spring constant. Here, fc is a function representing non-linearity of the spring constant.

A fifth term of the right side in Equation (1) indicates a viscous force of dashpot 113. A fifth term of the right side in Equation (2) indicates a viscous force of dashpot 116. Here, μ1 and μ2 indicate viscosity coefficients. Here, μ1 is expressed with the following Equation (5). Here, μ2 is expressed with the following Equation (6). Here, fμ is a function representing non-linearity of the viscous force. The vocal cord becomes harder the greater the viscous force, thus showing a state in which vibration is difficult to occur. Here, dx1/dt represents the speed of mass point 111. Here, dx2/dt represents the speed of mass point 114.

[Equation 5]

μ₁=2power(m₁k₁,0.5) (5)

[Equation 6]

μ₂=2power(m₂k₂,0.5) (6)

The above motion equations can be calculated by difference approximation such as Euler method, for example. Displacements x1, x2 of mass point 111 and mass point 114 are calculated by such calculation. That is, vocal cord model 110 is configured by a program that executes the simulation. After displacements x1, x2 are calculated, interval h1 of mass point 111 and mass point 121, and interval h2 of mass point 114 and mass point 124 are calculated according to the following Equations (7) and (8).

$$\begin{matrix}[ Equation 7 ] & \\ {h}_{1} = 2 ( {x}_{1} - \frac{X}{2} ) & ( 7 ) \\ [ Equation 8 ] & \\ {h}_{2} = 2 ( {x}_{2} - \frac{X}{2} ) & ( 8 )\end{matrix}$$

Here, h1 and h2 are transferred to vocal tract acoustic model 150. When information indicating h1 and h2 are transferred to vocal tract acoustic model 150, expiratory flow Ug changes (alternates) in vocal tract acoustic model 150. The resonance is generated by acoustic model 152 of the vocal tract after the vocal cord when expiratory flow Ug changes. As a result, desired audio signal Pv is calculated.

Here, X is an interval of the gap of the glottis in an equilibrium state when Φ, which is the opening degree of the throat, is Φ₀. For example, X is 0.2 cm. If Φ, which is the opening degree of the throat, is smaller than or equal to Φ₀−X, the value of X becomes zero. In this case, drag G1 and drag G2 act even in the equilibrium state. If Φ, which is the opening degree of the throat, is greater than Φ₀−X, the X takes a positive value. In this case, drag G1 and drag G2 do not act in the equilibrium state. Thus, the interval of the glottis in the equilibrium state, and drag G1 and drag G2 differ depending on the value of Φ, which is the opening degree of the throat. The equilibrium state is a natural state in which the voice is not vocalized.

The difference in the properties of audio signal Pv generated in the respective states of FIG. 3(a), FIG. 3(b), and FIG. 3(c) will now be described.

FIG. 3(a) shows the state of the vocal cord simulated when Φ=Φ₀. FIG. 3(a) shows, for example, the state of the vocal cord simulated at vocalization start time Tv(=TΦ) when “ [symbol] (Japanese pronunciation “a”)” is vocalized with the parameter value of the fifth row of message file 102 shown in FIG. 6 as Φ₀. In this case, Φ, which is the opening degree of the throat, maintains Φ even after vocalization start time Tv(=TΦ), as shown in FIG. 7(a). That is, in this case, the vocal cord continues to vibrate in the state shown in FIG. 3(a). The time waveform of x2, which is the displacement of mass point 114, in the state shown in FIG. 3(a) changes as shown in FIG. 8(a). That is, since a gap is formed in the glottis at vocalization start time Tv, a relatively long time is required until x2, which is the displacement of mass point 114, achieves stable vibration. The turbulence generates at a relatively large level in the gap of the vocal cord until x2, which is the displacement of mass point 114, reaches stable vibration. Generally, the turbulence has a component over a wide frequency band like white noise. In the present disclosure, the generation mechanism of such turbulence is modeled with turbulent noise source 159 shown in FIG. 4. The description on the internal configuration thereof will be omitted herein. According to the turbulence generated in such manner, as shown in FIG. 9(a), the non-integer order harmonic sound component of the pitch demonstrates a relatively large level for a constant period from vocalization start time Tv in amplitude frequency spectrum of audio signal Pv. The integer order harmonic sound component of the pitch corresponds to the resonance peak of FIG. 9(a). The non-integer order harmonic sound component of the pitch corresponds to the component that appears between (valley) the resonance peaks. The tone quality of audio signal Pv shown in FIG. 9(a) is such that the noise of breath is contained relatively abundantly at vocalization start time Tv. Therefore, although “ [symbol] (Japanese pronunciation “a”)” is being vocalized, a weak audio close to “ [symbol] (Japanese pronunciation “ha”)” is generated.

FIG. 3(b) shows the state of the vocal cord simulated when Φ=Φ₀−X. FIG. 3(b) shows, for example, the state of the vocal cord simulated at vocalization start time Tv(=TΦ) when “ [symbol] (Japanese pronunciation “a”)” is vocalized with the parameter value of the fifth row of message file 102 shown in FIG. 6 as Φ₀−X. In this case, Φ, which is the opening degree of the throat, transitions toward Φ₀ after becoming Φ0−X at the time point of vocalization start time Tv (=TΦ), as shown in FIG. 7(b). That is, in this case, the state shown in FIG. 3(b) transitions to the state shown in FIG. 3(a). The time waveform of x2, which is the displacement of mass point 114, in the state shown in FIG. 3(b) changes as shown in FIG. 8(b). That is, since the gap is barely opened in the glottis at vocalization start time Tv, x2, which is the displacement of mass point 114, reaches stable vibration in a relatively short time. In this case, not a lot of turbulence generates in the gap of the glottis. Therefore, the non-integer order harmonic sound component of the pitch does not become relatively large in the amplitude frequency spectrum of audio signal Pv, as shown in FIG. 9(b). As a result, the tone quality of audio signal Pv shown in FIG. 9(b) becomes the tone quality of normal “ [symbol] (Japanese pronunciation “a”)”.

FIG. 3(c) shows the state of the vocal cord simulated when Φ=Φ₀−2X. FIG. 3(c) shows, for example, the state of the vocal cord simulated at vocalization start time Tv(=TΦ) when “ [symbol] (Japanese pronunciation “a”)” is vocalized with the parameter value of the fifth row of message file 102 shown in FIG. 6 as Φ₀−2X. In this case, as shown in FIG. 7(c), Φ, which is the opening degree of the throat, transitions toward Φ₀ after becoming Φ₀−2X at the time point of vocalization start time Tv(=TΦ). That is, in this case, the state shown in FIG. 3(c) transitions to the state shown in FIG. 3(a). In this case, drag G1 and drag G2 act on mass point 111 and mass point 114 at vocalization start time Tv. Therefore, the time waveform of x2, which is the displacement of mass point 114, in the state shown in FIG. 3(c) changes as shown in FIG. 8(c). That is, the time waveform in this case becomes the waveform with disturbed periodicity immediately after vocalization start time Tv. As a result, the vocal cord vibration displacement is disturbed at vocalization start time Tv. The non-integer order harmonic sound component of the pitch thus becomes relatively large in the amplitude frequency spectrum of audio signal Pv, as shown in FIG. 9(c). As a result, the tone quality of audio signal Pv shown in FIG. 9(c) becomes the tone quality of “ [symbol] (Japanese pronunciation “a”)” in an yelling voice.

The operation has been described using a case of vocalizing the phoneme “ [symbol] (Japanese pronunciation “a”)” by way of example. Hereinafter, the vocalization of the phoneme involving a consonant such as “ [symbol] (Japanese pronunciation “ka”)” and “ [symbol] (Japanese pronunciation “na”)” will now be described with reference to FIG. 10.

FIG. 10 shows a list showing a calculation formula of TΦ of each phoneme form. In the case of a vowel (“ [symbol] (Japanese pronunciation table “a” column)”), TΦ is determined based on Equation (9). This is because the desired tone quality change can be realized by changing Φ at vocalization start time Tv(=TΦ), as described above. For the phoneme involving a consonant, it is not appropriate to control Φ at vocalization start time Tv. For the phoneme involving a consonant, a control close to the actual vocalization can be performed by controlling Φ at an instant of shifting from the consonant period to the vowel period.

In the case of a consonant not involving the vocal cord vibration such as “ [symbol] (Japanese pronunciation “ka”)”, TΦ is determined based on Equation (10). In the actual vocalization, the vicinity of the palatine sail shifts from a closed state to an opened state when shifting from the consonant period to the vowel period in the case of “ [symbol] (Japanese pronunciation “ka”)”. This time is defined as Tc1, and is described in the phoneme file of “ [symbol] (Japanese pronunciation “ka”)” in phoneme file group 101. Parameter control unit 103 determines TΦ based on Tc1 read out from phoneme file of “ [symbol] (Japanese pronunciation “ka”)” and Equation (10). At time Tc1, the operation of shifting the vicinity of the palatine sail from the closed state to the opened state is realized by setting acoustic inertance L and acoustic resistance R corresponding to the position of the palatine sail of acoustic model 152 of the vocal tract after the vocal cord sufficiently large and setting acoustic compliance C sufficiently small.

In the case of a consonant involving the vocal cord vibration such as “ [symbol] (Japanese pronunciation “na”)”, TΦ is determined based on Equation (11). In the actual vocalization, the vicinity of the palatine sail is switched from the state of letting the breath go only to the nose to the state of letting the breath go also to the mouth when shifting from the consonant period to the vowel period in the case of “ [symbol] (Japanese pronunciation “na”)”. This time is defined as Tc2, and is described in the phoneme file of “ [symbol] (Japanese pronunciation “na”)” in phoneme file group 101. Parameter control unit 103 determines TΦ based on Tc2 read out from the phoneme file of “ [symbol] (Japanese pronunciation “na”)” and Equation (11). At time Tc2, the operation of switching the vicinity of the palatine sail from the state of letting the breath go only to the nose to the state of letting the breath go also to the mouth is realized by switching switch 160 corresponding to the position of the palatine sail of acoustic model 152 of the vocal tract after the vocal cord from OFF to ON. Thus, Φ can be appropriately controlled according to the type of phoneme by the operations described above.

As described above, control unit 100, vocal cord model 110, and vocal tract acoustic model 150 are described with a program. However, such configuration is not necessary the sole case. For example, control unit 100, vocal cord model 110, and vocal tract acoustic model 150 may be realized by a digital electronic circuit, an analog electronic circuit, or a combination thereof.

[1-4. Effects, and the Like]

As described above, the generation method of the audio signal according to the present exemplary embodiment includes: inputting a plurality of variables including at least first variable Φ indicating an opening degree of a throat, which interiorly includes a vocal cord, with respect to a vocal cord model configured to output second variables h1, h2 indicating an opening degree of the vocal cord according to reception of input of the plurality of variables, first variable Φ being greater than second variables h1, h2; and generating an audio signal in which a level of a non-integer harmonic sound is changed by controlling second variables h1, h2.

Thus, the generation method of the audio signal according to the present exemplary embodiment can provide a synthesizing method of the audio signal capable of expressing strength and weakness of the tone such as weak voice and yelling voice.

Furthermore, in the generation method of the audio signal according to the present exemplary embodiment, the plurality of variables input to the vocal cord model include a variable set in advance for each phoneme.

Thus, the generation method of the audio signal according to the present exemplary embodiment can provide a synthesizing method of the audio signal capable of expressing strength and weakness of the tone such as weak voice and yelling voice.

The generation method of the audio signal according to the present exemplary embodiment differs the timing to control second variables h1, h2 according to the type of phoneme.

Thus, the generation method of the audio signal according to the present exemplary embodiment can bring the changing mode of the opening shape of the throat closer to a more realistic mode according to the type of phoneme. As a result, the generation method of the audio signal according to the present exemplary embodiment can provide the synthesizing method of the audio signal capable of expressing strength and weakness of the tone such as weak voice and yelling voice closer to the realistic voice.

### Second Exemplary Embodiment

A second exemplary embodiment will now be described with reference to the drawings.

[2-1. Outline]

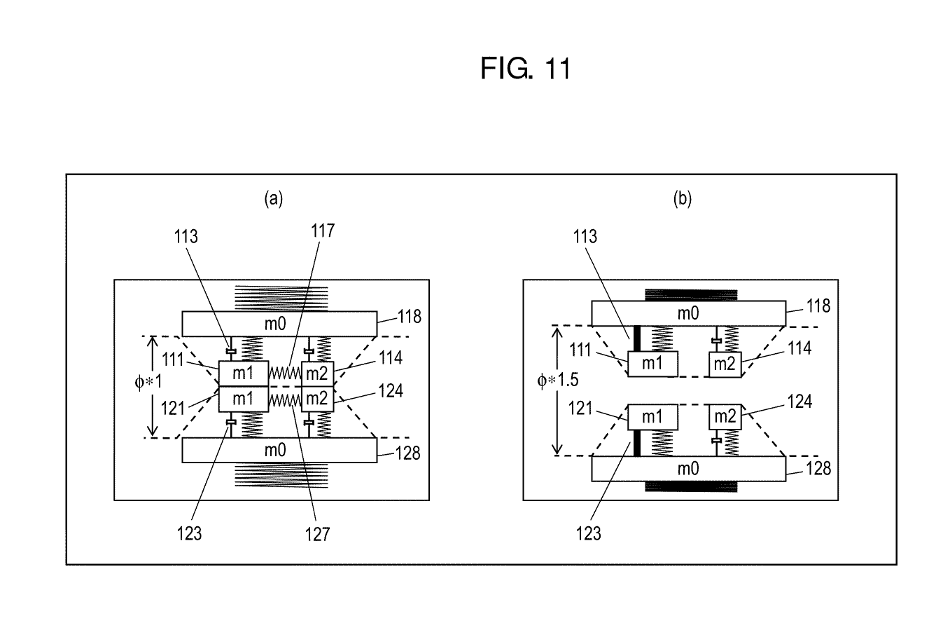

The outline of the audio synthesizing device according to the present exemplary embodiment will be described with reference to FIG. 11. FIG. 11 is a schematic view describing a plurality of states of vocal cord model 110. The audio synthesizing device according to the present exemplary embodiment differs from audio synthesizing device 500 according to the first exemplary embodiment in the function of the control unit. Specifically, the control unit according to the first exemplary embodiment is control unit 100, whereas the control unit according to the present exemplary embodiment is control unit 700. More specifically, control unit 100 according to the first exemplary embodiment does not control to which of the simple vibration mode or the coupled vibration mode to set the vibration mode of vocal cord model 110, whereas control unit 700 according to the present exemplary embodiment performs a control to change the vibration mode of vocal cord model 110 between the simple vibration mode and the coupled vibration mode.

The simple vibration mode is a mode in which mass point 111 and mass point 114 in vocal cord model 110 independently perform the simple vibration. The coupled vibration mode is a mode in which mass point 111 and mass point 114 of vocal cord model 110 vibrate in cooperation according to the tension of spring 117.

Specifically, when vocal cord model 110 is controlled in the coupled vibration mode, the state shown in FIG. 11(a) is simulated in vocal cord model 110. That is, vocal cord model 110 in this case has a configuration in which spring 117 exists between mass point 111 and mass point 114. When vocal cord model 110 is controlled in the simple vibration mode, the state shown in FIG. 11(b) is assumed in vocal cord model 110. That is, vocal cord model 110 in this case has a configuration in which spring 117 does not exist between mass point 111 and mass point 114.

Therefore, the audio synthesizing device according to the present exemplary embodiment controls the vibration mode of vocal cord model 110. The audio synthesizing device according to the present exemplary embodiment thus can more appropriately express high voice and natural voice.

The aspects different from audio synthesizing device 500 according to the first exemplary embodiment will be centrally described below with regards to the audio synthesizing device according to the present exemplary embodiment.

[2-2. Configuration of Control Unit]

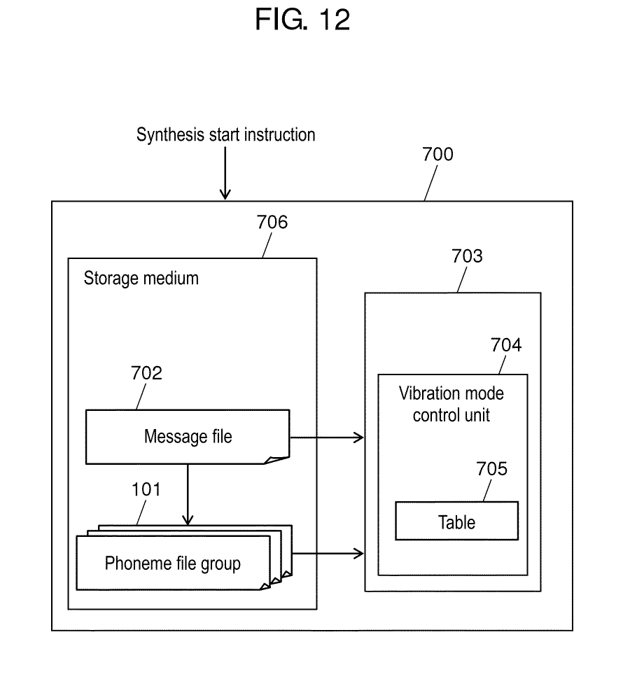

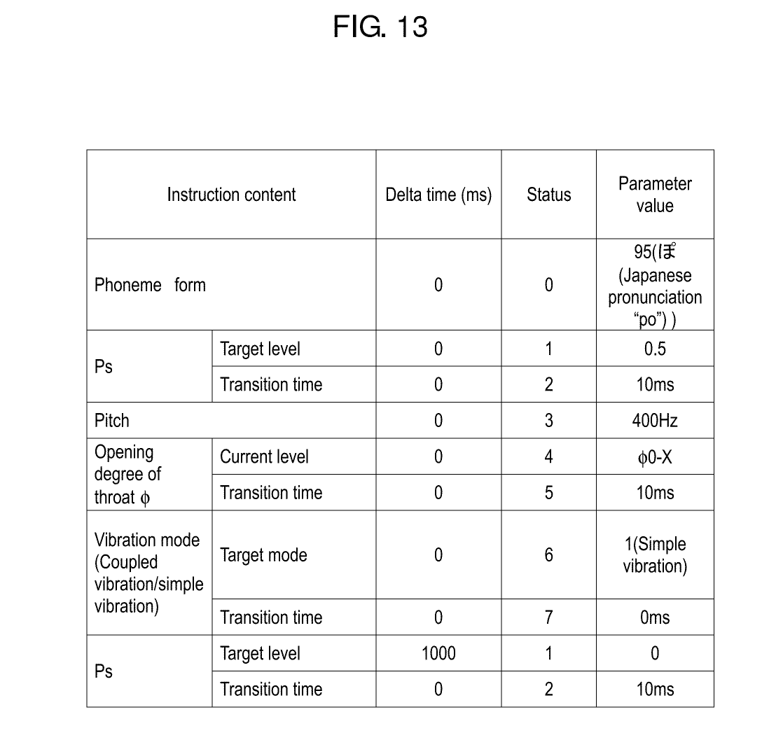

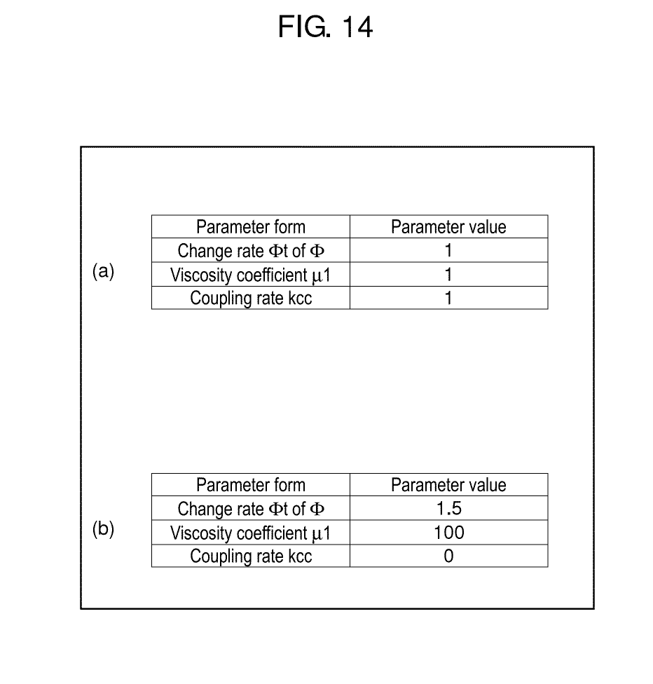

The configuration of control unit 700 will be described with reference to FIGS. 12 to 14. FIG. 12 is a schematic view showing a configuration of control unit 700. FIG. 13 is a schematic view showing a specific example of message file 702. FIG. 14 is a schematic view showing a specific example of information stored by table 705. Control unit 700 includes parameter control unit 703 and storage unit 706. Parameter control unit 703 is a controller for controlling the entire audio synthesizing device. Storage unit 706 is a memory for storing data.

Storage unit 706 stores phoneme file group 101 in advance. Storage unit 706 also stores message file 702 externally received with the synthesis start instruction. Phoneme file group 101 is similar to phoneme file group 101 according to the first exemplary embodiment. Message file 702 differs from message file 102 according to the first exemplary embodiment in that message file 702 includes a parameter value related to the vibration mode, as shown in FIG. 13. In other words, message file 702 differs from message file 102 according to the first exemplary embodiment in that message file 702 includes the parameter values indicated in statuses 6 and 7 shown in FIG. 13.

Parameter control unit 703 differs from parameter control unit 103 in that parameter control unit 703 has a function demonstrated in vibration mode control unit 704 and stores information indicated in table 705. That is, parameter control unit 703 differs from parameter control unit 103 according to the first exemplary embodiment in that parameter control unit 703 references the parameter value related to the vibration mode included in message file 702 and also references information indicated in table 705 to control audio signal generation unit 180.

[2-3. Operation]

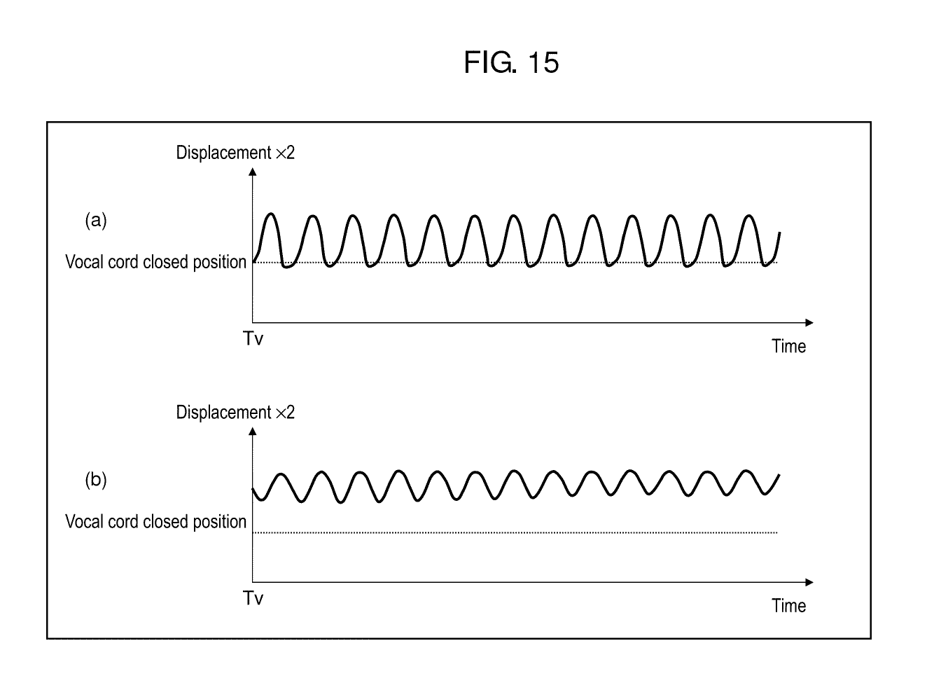

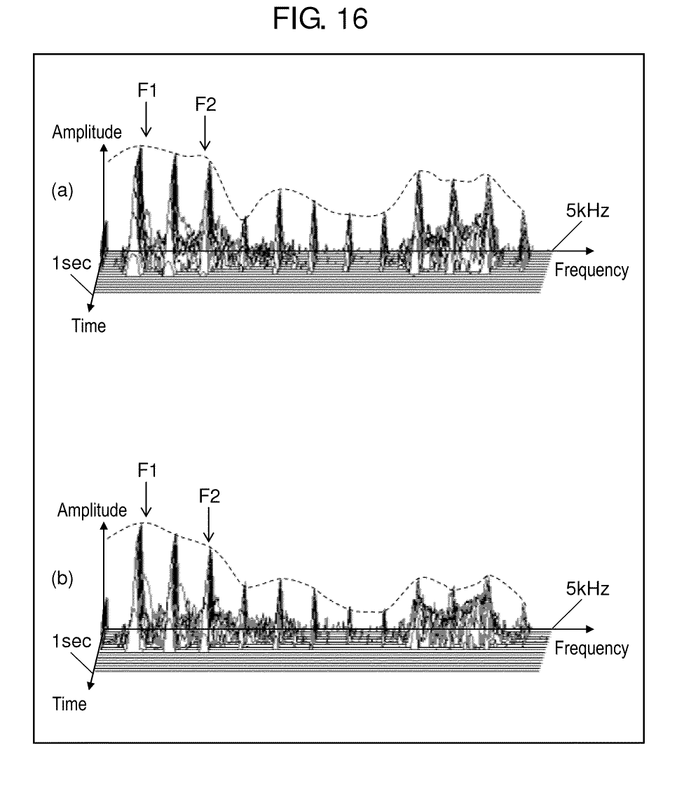

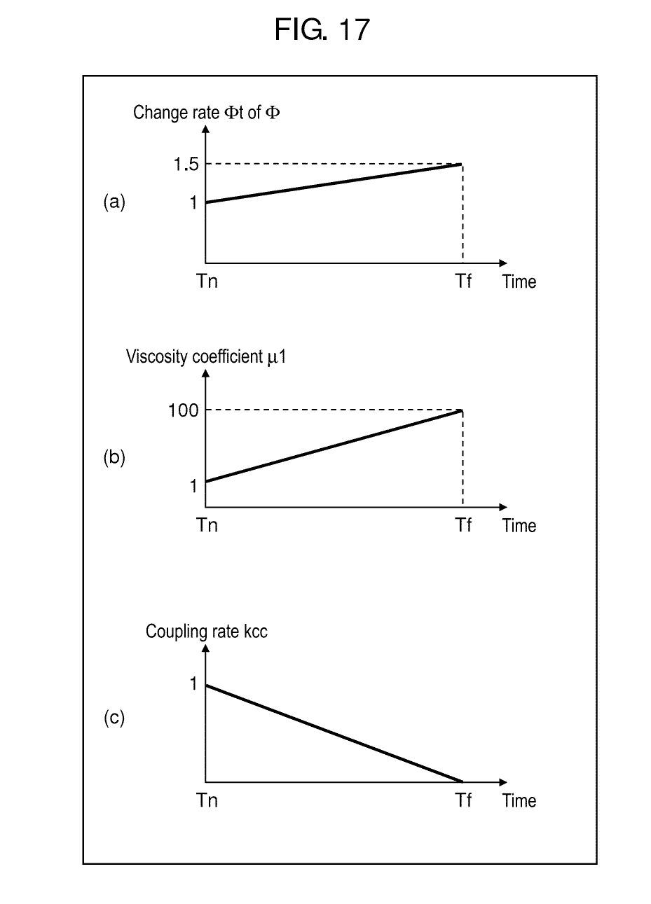

The operation of the audio synthesizing device according to the present exemplary embodiment will now be described with reference to FIGS. 15 to 17. FIG. 15 is a schematic view showing a time waveform of x2 indicating the displacement of mass point 114. FIG. 16 is a schematic view showing an amplitude frequency spectrum of audio signal Pv. FIG. 17 is a schematic view showing a changing example of various types of parameters when transitioning from the coupled vibration mode to the simple vibration mode.

The aspect in that the parameter value described in message file 702 shown in FIG. 13 is read up to the sixth row by parameter control unit 703 after externally receiving the synthesis start instruction is similar to the first exemplary embodiment. The difference with the first exemplary embodiment lies in that the seventh row and the eighth row of the parameter values described in message file 702 are thereafter read by parameter control unit 703. The parameter values of the seventh row and the eighth row are parameter values indicating the set vibration mode. The seventh row is status 6. Status 6 indicates that the corresponding parameter value is the target mode of the vibration mode. If the parameter value corresponding to status 6 is zero, this means that the vibration mode is the coupled vibration mode, whereas if the parameter value is one, this means that the vibration mode is the simple vibration mode. The eighth row is status 7. Status 7 indicates the time required for the corresponding parameter value to transition from the currently set vibration mode to the target mode. Assume that the currently set vibration mode is the coupled vibration mode at reference time T0 at which the synthesis start instruction is received. Therefore, the vibration mode is instantly switched from the coupled vibration mode to the simple vibration mode at time T0 in the example shown in FIG. 13.

When determining that the vibration mode switched to the simple vibration mode, vibration mode control unit 704 references various types of parameter values described in table 705 shown in FIG. 14(b). Here, the change rate Φt of Φ is a coefficient to be multiplied to Φ calculated based on the statuses 4 and 5.

Parameter control unit 703 transfers Φ, which is the result of multiplying Φt to Φ, to vocal cord model 110. The value of Φt in the simple vibration mode is 1.5 times the value of Φt in the coupled vibration mode. Therefore, the opening degree Φ of the throat in vocal cord model 110 expands by 1.5 times as shown in FIG. 11(b). Viscosity coefficient μ1 is set with respect to dashpot 113 and dashpot 123. The value of viscosity coefficient μ1 in the simple vibration mode is a sufficiently large value of 100 times viscosity coefficient μ1 in the coupled vibration mode. Therefore, the vibration of mass point 111 and mass point 121 is stopped. The dashpot in this state is shown with a thick line in FIG. 11(b). A coupling rate kcc is a coefficient to be multiplied to spring constant kc of spring 117 and spring 127. Parameter control unit 703 transfers kc, which is the result of multiplying kcc to kc, to vocal cord model 110. Since the value of kcc in the simple vibration mode is zero, the value of kc after the multiplication becomes zero. Therefore, the coupled state of mass point 111 and mass point 114, as well as the coupled state of mass point 121 and mass point 124 are separated as shown in FIG. 11(b).

According to the control described above, vocal cord model 110 is in the simple vibration mode in which mass point 114 and mass point 124 respectively performs the simple vibration. In this case, Φ becomes larger than the coupled vibration mode, and hence mass point 114 and mass point 124 do not collide. Therefore, the time waveform of displacement x2 becomes a shape close to a sine wave, as shown in FIG. 15(b).

Assuming the parameter value corresponding to status 6 of message file 702 is zero, the vibration mode of vocal cord model 110 can be set to the coupled vibration mode. In this case, table 705 shown in FIG. 14(a) is referenced. Therefore, vocal cord model 110 becomes the state shown in FIG. 11(a), that is, the coupled vibration mode. The time waveform of displacement x2 in this case becomes a shape close to a saw-tooth wave shape, as shown in FIG. 15(a).

The amplitude frequency spectrum of audio signal Pv when the vibration mode of vocal cord model 110 is set to the simple vibration mode is as shown in FIG. 16(b). The amplitude frequency spectrum of audio signal Pv when the vibration mode of vocal cord model 110 is set to coupled vibration mode is as shown in FIG. 16(a). That is, the level of the high-order integer order harmonic sound component of audio signal Pv when the vibration mode of vocal cord model 110 is set to the simple vibration mode is attenuated more than the level of the high order integer order harmonic sound component of audio signal PV when the vibration mode is set to the coupled vibration mode. The levels of first formant F1 and second formant F2 of audio signal Pv when the vibration mode of vocal cord model 110 is set to the simple vibration mode are attenuated more than the levels of first formant F1 and second formant of audio signal Pv when the vibration mode is set to the coupled vibration mode. However, the attenuation rate of first formant F1 and second formant F2 is low compared to the attenuation rate of the high order integer order harmonic sound component. In other words, first formant F1 and second formant F2 are saved in the simple vibration mode as well as in the coupled vibration mode. Message file 702 shown in FIG. 13 is an example of synthesizing the phoneme “ [symbol] (Japanese pronunciation “po”)” at pitch 400 Hz. In the case of the phoneme of “ [symbol] (Japanese pronunciation table “o” column)” such as “ [symbol] (Japanese pronunciation “po”)”, first formant F1 has characteristics existing in the vicinity of about 500 Hz, and second formant F2 has characteristics existing in the vicinity of about 1 kHz. With reference to FIGS. 16(a) and 16(b), it can be seen that such characteristics are saved.

As described above, FIG. 17 is a schematic view showing a changing example of various types of parameters when transitioning from the coupled vibration mode to the simple vibration mode. More specifically, FIG. 17(a) is a view showing the temporal change of variable Φt, which is the change rate of variable Φ indicating the opening degree of the throat. FIG. 17(b) is a view showing the temporal change of viscosity coefficient μ1. FIG. 17(c) is a view showing the temporal change of coupling rate kcc.

When performing the control as shown in FIGS. 17(a), 17(b) and 17(c), the coupled vibration mode is specified as the vibration mode in message file 702, the simple vibration mode is specified as the vibration mode after (Tf−Tn) time, and furthermore, the transition time from the coupled vibration mode to the simple vibration mode is specified. In such a case, vibration mode control unit 704 performs the interpolation computation process so that each parameter value described in table 705 transitions from the parameter value shown in FIG. 14(a) to the parameter value shown in FIG. 14(b). According to such control, audio signal Pv continuously changes from the audio signal shown in FIG. 16(a) to the audio signal shown in FIG. 16(b).

Control unit 700, vocal cord model 110, and vocal tract acoustic model 150 may all be described with a program, or may be realized with a digital electronic circuit, an analog electronic circuit, or a combination thereof, similar to the first exemplary embodiment.

The coupled vibration mode and the simple vibration mode may be paraphrased as the natural voice mode and the high voice mode. When switching such modes, problems do not arise in terms of tone quality even if Φ is not controlled. Furthermore, each parameter is preferably controlled in a temporally cooperative manner when transitioning from the natural voice to the high voice or from the high voice to the natural voice.

[2-4. Effects, and the Like]

Accordingly, the generation method of the audio signal according to the present exemplary embodiment includes: inputting a plurality of variables including at least first variable Φ indicating an opening degree of a throat, which interiorly includes a vocal cord, with respect to a vocal cord model configured to output second variables h1, h2 indicating an opening degree of the vocal cord according to reception of input of the plurality of variables, first variable Φ being greater than second variables h1, h2; and generating an audio signal in which a level of a non-integer order harmonic sound is changed by controlling second variables h1, h2. The generation method of the audio signal according to the present exemplary embodiment also includes receiving an instruction for setting to either a natural voice mode or a high voice mode. Furthermore, the generation method of the audio signal according to the present exemplary embodiment includes generating an audio signal in which levels of a first formant frequency, a second formant frequency, and a high-order integer harmonic sound are attenuated when receiving an instruction for setting to the high voice mode compared to when receiving an instruction for setting to the natural voice mode, an attenuation rate of the levels of the first formant frequency and the second formant frequency being lower than an attenuation rate of the level of the high-order integer harmonic sound.

The generation method of the audio signal according to the present exemplary embodiment thus can control the level of the high-harmonic sound, which is the characteristic on whether or not the high voice.

The exemplary embodiments have been described as an illustration of the technique in the present disclosure. The accompanying drawings and the detailed description are provided therefor.

Therefore, the configuring elements described in the accompanying drawings and the detailed description include not only the configuring elements essential for achieving the object but also configuring elements not essential for achieving the object in order to illustrate the technique. Thus, it should not be immediately recognized that the non-essential configuring elements are essential just because such non-essential configuring elements are described in the accompanying drawings and the detailed description.

The exemplary embodiments described above illustrate the technique in the present disclosure, and hence various modifications, replacements, additions, omissions, and the like can be carried out within the scope of the Claims or the equivalent thereto.

The present disclosure can be applied to the generation method of the audio signal and the audio synthesizing device.

What is claimed is:

1. A method of generating an audio signal, the method comprising:
inputting a plurality of variables including at least a first variable indicating an opening degree of a throat, which interiorly includes a vocal cord, with respect to a vocal cord model configured to output a second variable indicating an opening degree of the vocal cord according to reception of input of the plurality of variables, the first variable being greater than the second variable; and
generating an audio signal in which a level of a non-integer order harmonic sound is changed, by controlling the second variable.

2. The method of generating an audio signal according to claim 1, wherein the plurality of variables includes a variable set in advance for each phoneme.

3. The method of generating an audio signal according to claim 1, wherein timing for controlling the second variable is differed according to a type of phoneme.

4. The method of generating an audio signal according to claim 1, further comprising:
receiving an instruction for setting to either a natural voice mode or high voice mode; and
generating an audio signal in which levels of a first formant frequency, a second formant frequency, and a high-order integer harmonic sound are attenuated when receiving the instruction for setting to the high voice mode compared to when receiving the instruction for setting to the natural voice mode, an attenuation rate of the levels of the first formant frequency and the second formant frequency being lower than an attenuation rate of the level of the high-order integer order harmonic sound.

5. The method of generating an audio signal according to claim 1, wherein
the vocal cord model simulates an inclusion of,
a first mass point coupled to a first fixed end via a first spring,
a second mass coupled to a second fixed end, disposed at a position facing the first fixed end, in a direction opposing the first mass point by way of a second spring,
a third mass point coupled to a surface opposite to a surface, on which the first spring is disposed, by way of a third spring at above the first mass point,
a fourth mass point coupled to a surface opposite to a surface, on which the first spring is disposed, by way of a fourth spring at above the first mass point,
a fifth mass point coupled to a surface opposite to a surface, on which the second spring is disposed, in a direction opposing the third mass point by way of a fifth spring at above the second mass point,
a sixth mass point coupled to a surface on a side opposite to a surface, on which the second spring is arranged, by way of a sixth spring at above the second mass point,
wherein
a distance between the first mass point and the second mass point is simulated as a variable indicating the opening degree of the throat, and
a distance between the third mass point and the fifth mass point, and a distance between the fourth mass point and the sixth mass point are simulated as a variable indicating the opening degree of the vocal cord.

6. The generation method of an audio signal according to claim 5, further comprising:
receiving an instruction for setting to either a natural voice mode or a high voice mode; and
generating an audio signal in which levels of a first formant frequency, a second formant frequency, and a high-order integer order harmonic sound component are attenuated when receiving the instruction for setting to the high voice mode compared to when receiving the instruction for setting to the natural voice mode, an attenuation rate of the levels of the first formant frequency and the second formant frequency being lower than an attenuation rate of the level of the high-order integer order harmonic sound component,
wherein
the vocal cord model further simulates an inclusion of,
a seventh spring configured to couple the third mass point and the fourth mass point, and
an eighth spring configured to couple the fifth mass point and the sixth mass point, and
the natural voice mode and the high voice mode are switched by controlling at least spring constants of the seventh spring and the eighth spring.

7. An audio synthesizing device comprising:
an input unit configured to input a plurality of variables including at least a first variable indicating an opening degree of a throat, which interiorly includes a vocal cord, with respect to a vocal cord model configured to output a second variable indicating an opening degree of the vocal cord according to reception of input of the plurality of variables; and
a generation unit configured to generate an audio signal in which a level of a non-integer order harmonic sound is changed, by controlling the second variable.
